(19) United States
(12) Patent Application Publication
(10) Pub. No.: US 2018/0368525 A1
(43) Pub. Date: Dec. 27, 2018

(54) Sport Shoes

(71) Applicant: Mizuno Corporation, Osaka (JP)

(72) Inventors: Kazunori Iuchi, Osaka (JP); Chie Yamamoto, Osaka (JP)

(21) Appl. No.: 16/015,555

(22) Filed: Jun. 22, 2018

(30) Foreign Application Priority Data
Jun. 27, 2017 (JP) 2017-125600

(51) Int. Cl. A43B 23/02; A43B 5/00; A43B 1/14; A43B 13/04; A43B 13/12; B32B 5/02; B32B 25/08; B32B 25/10; B32B 7/12; B32B 37/12

(52) U.S. Cl. CPC A43B 23/0235; B32B 2037/1223; A43B 5/00; A43B 23/0215; A43B 1/14; A43B 13/04; A43B 13/12; B32B 5/026; B32B 25/08; B32B 25/10; B32B 7/12; B32B 37/1207; B32B 2307/51; B32B 2262/0292; B32B 2262/0276; B32B 2307/54; B32B 2437/02; A43B 23/027

(57) ABSTRACT

An upper includes a reinforcement portion to reinforce the mechanical strength of first and second fabric materials. The reinforcement portion has such strain rate dependence that in a room temperature range, as a strain rate in a stretch direction of the first and second fabric materials increases, a tensile load per unit width with respect to the strain amount increases and the reinforcement portion becomes less stretchable. In the reinforcement portion, a reinforcement member made of a thermoplastic elastomer is sandwiched between, and integrated with, the first and second fabric materials. The reinforcement portion extends continuously from an upper portion of a midsole to a position corresponding to a foot instep region of a wearer's foot.

### CROSS-REFERENCE TO RELATED APPLICATION

This application claims priority to Japanese Patent Application No. 2017-125600 filed on Jun. 27, 2017, the entire disclosure of which is incorporated by reference herein.

### BACKGROUND

The present disclosure relates to sport shoes.

Shoes including an upper for covering the instep of a foot have been known from International Publication No. 2008/047659, for example. This upper includes a mesh material having meshes and a reinforcement part sewn on a position of the top surface of the mesh material corresponding to a tiptoe region of the foot. The reinforcement part is made of a material that is difficult to stretch, such as artificial leather, and is designed for maintaining the shape of a partial area of the upper (for example, a portion corresponding to a front region of a foot including the toes).

### SUMMARY

Meanwhile, it is generally desirable, for sport shoes or the like, that for example, each upper has such fitting properties that it fits the shape of a foot of a person wearing the shoes (hereinafter referred to as the “wearer”) when the wearer puts on the shoes, whereas the upper has such holding properties that it firmly covers and holds the wearer's foot when the wearer does heavy exercise.

However, the known shoes as disclosed in International Publication No. 2008/047659 have a problem: the upper having the reinforcement part that is difficult to stretch covers and firmly holds a wearer's foot, while the upper is difficult to stretch and to fit the shape of the wearer's foot when the wearer puts on the shoes. Specifically, the shoes of International Publication No. 2008/047659 merely exhibit their holding properties when the wearer wearing the shoes does heavy exercise and a sudden external force is applied to the uppers. Unfortunately, when a gentle external force is applied to the uppers in a situation where the wearer puts on the shoes, for example, the fitting properties that are generally needed are impaired. Thus, it is difficult for shoes as disclosed in International Publication No. 2008/047659 to have both the holding property and the fitting property and to exhibit the fitting or holding properties according to a state of usage.

Further, the reinforcement part is merely sewn on the top surface of the mesh material. In other words, the reinforce part is exposed to the outside of the mesh material. Therefore, for example, the reinforcing parts of the shoes of International Publication No. 2008/047659 are likely to be caught on an object when the wearer is playing an athletic game, and involve the risk of peeling off the mesh material.

In view of the foregoing background, it is therefore an object of the present disclosure to enable an upper to have both fitting properties and holding properties and to exhibit the fitting or holding properties according to a state of usage, while reducing risk of damage to a reinforcement portion so as to prolong the life of a shoe.

To achieve the above object, a first aspect of the present disclosure is directed to a sport shoe. The sport shoe includes: a sole configured to support a plantar surface of a foot of a wearer; and an upper coupled to an upper portion of the sole and configured to cover the wearer's foot. The upper includes: a first fabric material and a second fabric material which are stretchable and overlaid each other; and a reinforcement portion which has such strain rate dependence that in a room temperature range, as a strain rate in a stretch direction of the first and second fabric materials increases, a tensile load per unit width with respect to a strain amount increases and the reinforcement portion becomes less stretchable. In the reinforcement portion, a reinforcement member made of a thermoplastic elastomer is sandwiched between the first and second fabric materials and integrated with at least one of the first or second fabric materials, and the reinforcement portion continuously extends from the upper portion of the sole to a position corresponding to a foot instep region of the wearer's foot.

According to the first aspect, the reinforcement portion of the upper that has the strain rate dependence enables the sport shoe to have both the fitting properties and the holding properties and to exhibit the fitting or holding properties according to a state of usage. Further, in the reinforcement portion, the reinforcement member is sandwiched between the first and second fabric materials and integrated with at least one of the first or second fabric materials. Consequently, the reinforcement member is less likely to be affected by an outside air temperature and a body temperature of the foot. In addition, the risk of being caught on an object when the wearer is playing an athletic game is reduced, for example, thereby substantially preventing the reinforcement member from peeling off the first and second fabric materials. Moreover, in the reinforcement portion, the reinforcement member extends continuously from the upper portion of the sole to the position corresponding to the foot instep of the wearer's foot. As a result, the strain rate dependence of the reinforcement portion provides the above effects to a region from a portion near the planta to the foot instep region in three dimensions, and points from which the reinforcement member can peel off are reduced, making it possible to reduce the risk of damage to the reinforcement portion. Thus, according to the first aspect of the present disclosure, the upper can have both fitting properties and holding properties and exhibit the fitting or holding properties according to a state of usage, and the risk of damage to the reinforcement portion is reduced, thereby prolonging the life of the sport shoe. Note that the “tensile load per unit width” refers to the value of a tensile load (N/mm) applied to a unit width, where a direction intersecting with the stretch direction of the first and second fabric materials is defined as the width direction and a dimension of the upper in the width direction is converted to the unit width of 1 mm.

A second aspect of the present disclosure is an embodiment of the first aspect. In the second aspect, in the reinforcement portion, a back surface of the reinforcement member is fusion bonded to a front surface of the first fabric material, and a front surface of the reinforcement member is fusion bonded to a back surface of the second fabric material.

In the second aspect, since the reinforcement member is firmly fixed to the first and second fabric materials, the reinforcement member easily follows the expansion and contraction of the first and second fabric materials, and the reinforcement member is less likely to peel off the first and second fabric materials.

A third aspect of the present disclosure is an embodiment of the first aspect. In the third aspect, the reinforcement member has a plurality of slits or plurality of holes formed in the reinforcement member.

According to the third aspect, the plurality of slits or holes contributes to improvement of the flexibility and air permeability of the reinforcement portion.

A fourth aspect of the present disclosure is an embodiment of the first aspect. In the fourth aspect, a measurement of a sample of the reinforcement member performed using dynamic viscoelasticity measuring equipment shows that the reinforcement member has such physical properties that a value of loss tangent tanδ reaches a peak value in the room temperature range equal to higher than 0° C. and lower than 40° C., where the measurement is performed under conditions that a rate of temperature rise is set to be 2° C./min, the temperature rise is started from −40° C., a temperature increment is set to be 2° C., and the temperature rise is ended at 50° C.

According to the fourth aspect, employing, as the reinforcement member, a thermoplastic elastomer having such physical properties that the value of loss tangent tanδ reaches its peak value in the room temperature range equal to or higher than 0° C. and lower than 40° C. contributes to enhancement of the strain rate dependence of the reinforcement portion within room temperature range in the atmospheric environment.

A fifth aspect of the present invention is an embodiment of the fourth aspect. In the fifth aspect, the reinforcement member is made of an olefin-based thermoplastic elastomer, and a measurement of a sample of the reinforcement member performed using the dynamic viscoelasticity measuring equipment shows that the reinforcement member has such physical properties that the value of loss tangent tanδ reaches a peak value in the temperature range from 24° C. to 32° C.

According to the fifth aspect, employing, as the reinforcement member, an olefin-based thermoplastic elastomer having such physical properties that the value of loss tangent tanδ reaches its peak value in the temperature range from 24° C. to 32° C. contributes to further enhancement of the strain rate dependence of the reinforcement portion within room temperature range in common sport facilities.

A sixth aspect of the present disclosure is an embodiment of the fourth aspect. In the sixth aspect, a direction intersecting with the stretch direction of the first and second fabric materials is defined as a width direction, for the reinforcement portion, a strain rate of 100%/s in the stretch direction of the first and second fabric materials is defined as a reference strain rate, a strain rate region with strain rates higher than the reference strain rate is defined as a high strain rate region, a strain rate region with strain rates equal to or lower than the reference strain rate is defined as a low strain rate region, and in a tensile test conducted on a sample of the reinforcement portion under conditions that ambient temperature of a tensile tester is within the room temperature region, the reinforcement portion exhibits such strain rate dependence that the tensile load per unit width with respect to the strain amount is higher and the reinforcement portion is less stretchable when the strain rate of the reinforcement portion is in the high strain rate region than when the strain rate of the reinforcement portion is in the low strain rate region.

Just like the first aspect, the sport shoe of the sixth aspect can have both the fitting properties and the holding properties and exhibit the fitting or holding properties according to a state of usage.

A seventh aspect of the present disclosure is an embodiment of the sixth aspect. In the seventh aspect, a relationship between the strain and the tensile load per unit width determined by the tensile test is that the tensile load P per unit width (N/mm) with respect to a strain amount of 1% is within the range of 0.11≤P≤4.34 in the low strain rate region, whereas the tensile load P is within the range of 0.84≤P≤7.11 in the high strain rate region.

According to the seventh aspect, setting the tensile load per unit width with respect to a strain amount of 1% within the respective numerical range can specifically achieve the reinforcement portion having such strain rate dependence that the reinforcement portion is flexible and easy to stretch in the low strain rate region whereas it is harder and less stretchable in the high strain rate region than in the low strain rate region.

An eighth aspect of the present disclosure is an embodiment of the sixth aspect. In the eighth aspect, a relationship between the strain and the tensile load per unit width determined by the tensile test is that the tensile load P per unit width (N/mm) with respect to a strain amount of 5% is within the range of 0.16≤P≤12.25 in the low strain rate region, whereas the tensile load P is within the range of 1.16≤P≤18.80 in the high strain rate region.

According to the eighth aspect, setting the tensile load per unit width with respect to a strain amount of 5% within the respective numerical range can specifically achieve the reinforcement portion having such strain rate dependence that the reinforcement portion is flexible and easy to stretch in the low strain rate region whereas it is harder and less stretchable in the high strain rate region than in the low strain rate region.

As can be seen from the foregoing, according to the present disclosure, the upper can have both fitting properties and holding properties and exhibits the fitting or holding properties according to a state of usage, and the risk of damage to the reinforcement portion can be reduced, thereby prolonging the life of the sport shoe.

### BRIEF DESCRIPTION OF THE DRAWINGS

FIG. 1 is a perspective view of a shoe according to a first embodiment of the present disclosure.

FIG. 2 is a plan view showing the shoe according to the first embodiment of the present disclosure, together with the skeletal structure of a foot.

FIG. 3 is a side view viewed from a lateral side and showing the shoe according to the first embodiment of the present disclosure, together with the skeletal structure of a foot.

FIG. 4 is a vertical cross-sectional view showing the structure of a reinforcement portion.

FIG. 5 is a plan view of a reinforcement member before being fusion bonded to the first and second fabric materials and in an expanded state.

FIG. 6 is a perspective view of a shoe according to a second embodiment of the present disclosure.

FIG. 7 is a perspective view of a shoe according to a third embodiment of the present disclosure.

FIG. 8 corresponds to FIG. 5, and shows a first variation of the reinforcement member of the first embodiment.

FIG. 9 corresponds to FIG. 5, and shows a second variation of the reinforcement member of the first embodiment.

FIG. 10 is a graph showing the results of a dynamic viscoelasticity measurement (behavior of loss tangent tanδ) of samples.

FIG. 11 schematically shows the shape of each sample.

FIG. 12 is a graph showing the results of a tensile test on Sample 6 (a relationship between strain and a tensile load per unit width).

FIG. 13 is a graph showing the results of a tensile test on Sample 17 (a relationship between strain and a tensile load per unit width).

FIG. 14 is a graph showing the results of a tensile test on Sample 26 (a relationship between strain and a tensile load per unit width).

### DETAILED DESCRIPTION

Embodiments of the present disclosure will now be described in detail with reference to the drawings. Note that the following description of the embodiments is a mere example in nature, and is not intended to limit the scope, application, or uses of the present disclosure.

### First Embodiment

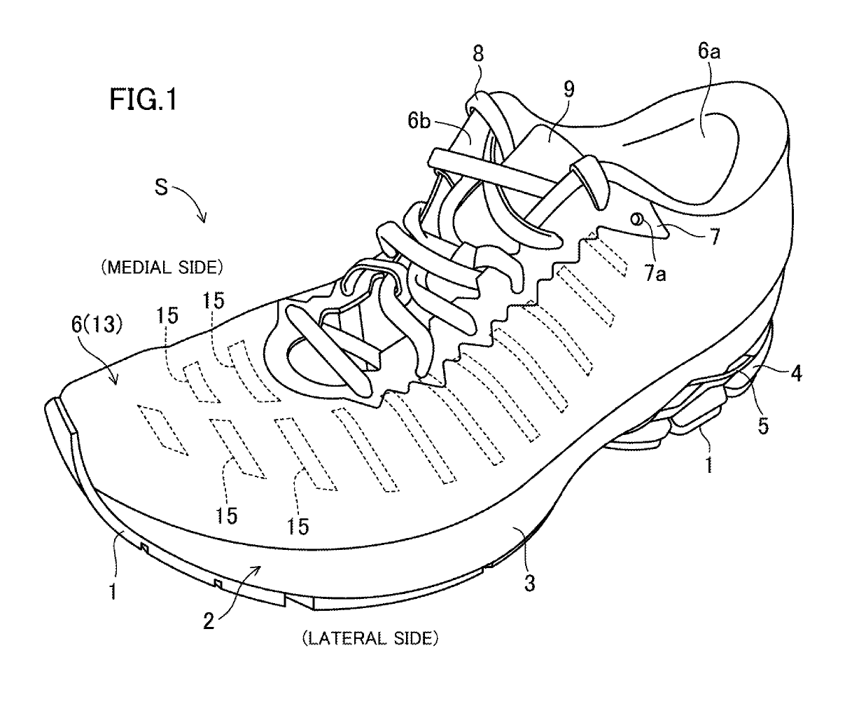

FIGS. 1 to 3 show the whole structure of a shoe S according to a first embodiment of the present disclosure. A pair of shoes S may be used, for example, as sport shoes for running and various athletic games.

The drawings illustrate a left shoe S only as an example. Since the right shoe is symmetrical to the left shoe, only the left shoe will be described in the following description, and the description of the right shoe will be omitted herein.

In the following description, the expressions “above,” “upward,” “on a/the top of,” “below,” “under,” and “downward,” represent the vertical positional relationship between respective components of the shoe S. The expressions “front,” “fore,” “forward,” “anterior,” “rear,” “hind,” “behind,” “backward,” and “posterior” represent the positional relationship in the longitudinal direction between respective components of the shoe S. The expressions “medial side” and “lateral side” represent the positional relationship in the foot width direction between respective components of the shoe S. Further, a “foot instep region” used herein refers to a region, of a foot of a person wearing the shoe S (hereinafter referred to as the “wearer”), in which the first to fifth proximal phalanxes and the first to fifth metatarsals are located.

As shown in FIGS. 1 to 3, the shoe S includes an outsole 1 which extends from a forefoot F to a hindfoot H of a foot of the wearer. The outsole 1 is made from a hard elastic material which is harder than the material for a midsole 2, which will be described later.

Examples of suitable materials for the outsole 1 include, but not are limited to, thermoplastic resins such as ethylene-vinyl acetate copolymer (EVA), thermosetting resins such as polyurethane (PU), and rubber materials such as butadiene rubber and chloroprene rubber. The outsole 1 has, on its lower surface, a ground surface configured to touch the ground.

The shoe S further includes the midsole 2 which supports a plantar surface extending from the forefoot F to the hindfoot H. The midsole 2 is made of a soft elastic material. Examples of suitable materials for the midsole 2 include, but are not limited to, thermoplastic synthetic resins such as ethylene-vinyl acetate copolymer (EVA) and foams of the thermoplastic synthetic resins, thermosetting resins such as polyurethane (PU) and foams of the thermosetting resins, and rubber materials such as butadiene rubber and chloroprene rubber and foams of the rubber materials. The midsole 2 is stacked on the outsole 1, while having a lower portion thereof bonded to an upper portion of the outsole 1 with an adhesive or other means. The midsole 2 is divided into portions arranged in the vertical direction. Specifically, the midsole 2 is a multilayer including an upper midsole 3 and a lower midsole 4 stacked below the upper midsole 3.

A corrugated plate 5 is disposed between the upper and lower midsoles 3 and 4 such that the corrugated plate 5 corresponds to the hindfoot H of the foot. The corrugated plate 5 has a corrugated shape having peaks and valleys alternating with each other in the longitudinal direction.

An upper 6 configured to cover the wearer's foot is provided on the periphery of the upper midsole 3. The upper 6 is configured to cover the wearer's foot, from the tiptoe of the forefoot F to the rear side of the heel of the hindfoot H.

The upper 6 has a lower portion coupled to an upper portion of the midsole 2. Specifically, the periphery of the lower portion of the upper 6 is integrally fixed to the entire periphery of the upper midsole 3 with an adhesive or the like.

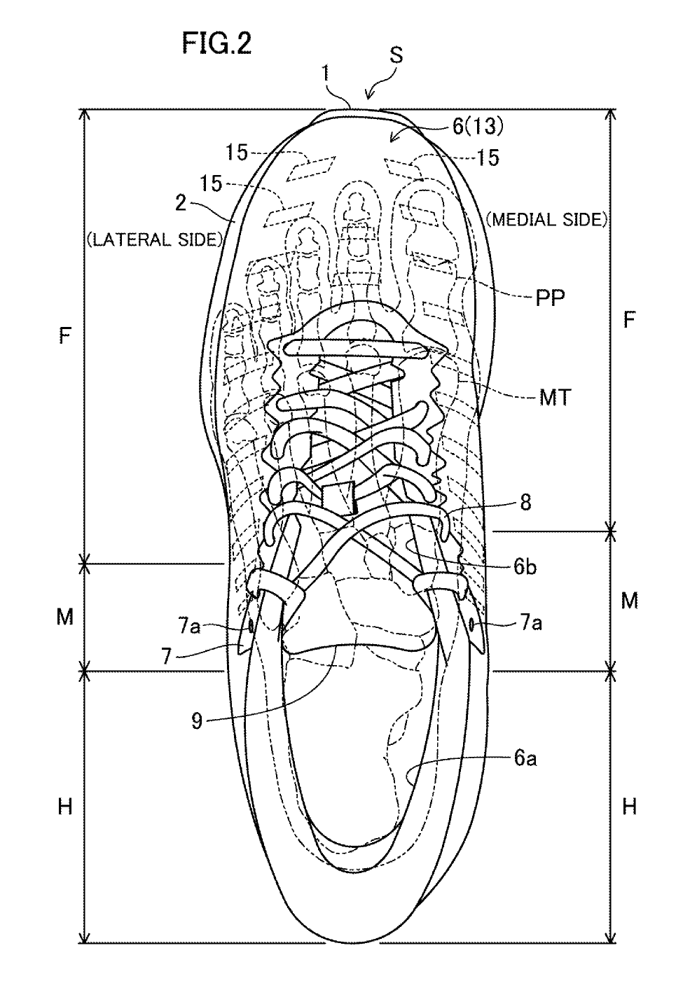

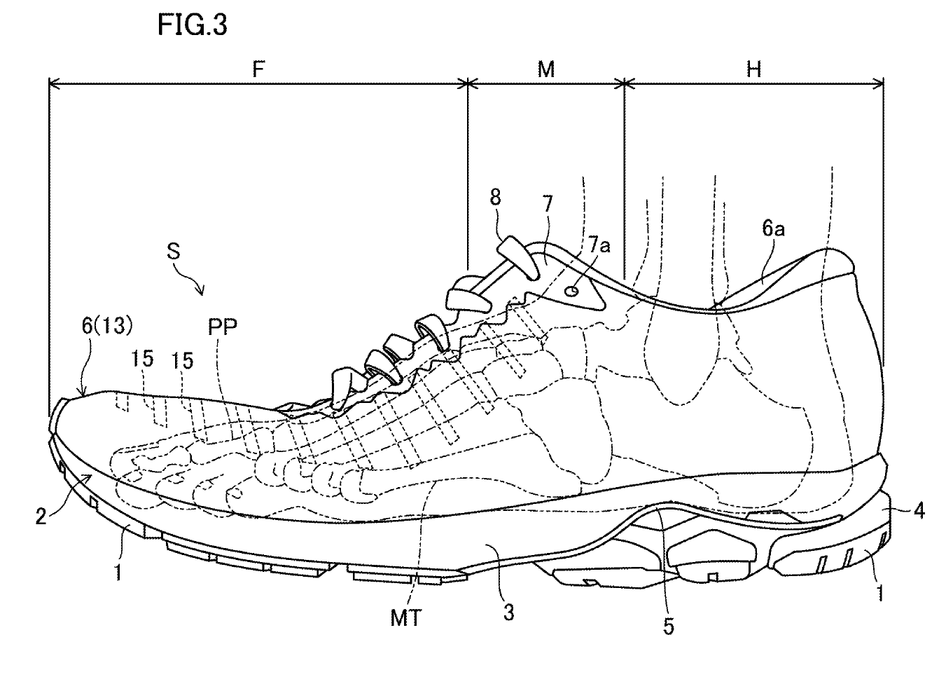

The upper 6 has, in its top portion, an ankle opening 6a through which the wearer inserts his/her foot, and a throat opening 6b which is continuous with the ankle opening 6a and extends in the longitudinal direction. In the top portion of the upper 6, an eyelet trimming part 7 is fixed along the throat opening 6b by, for example, sewing. The eyelet trimming part 7 is arranged to correspond to a foot instep region of the wearer's foot, i.e., to correspond to the proximal phalanxes and the metatarsals of the wearer's foot (see FIGS. 2 and 3). The eyelet trimming part 7 has, in its left and right edge portions, eyelet holes 7a, 7a, . . . which are arranged at intervals in the longitudinal direction and penetrate the eyelet trimming part 7. A shoe lace 8 is allowed to pass through the eyelet holes 7a. Further, a tongue 9 is attached to a front edge of the throat opening 6b to open and close the throat opening 6b.

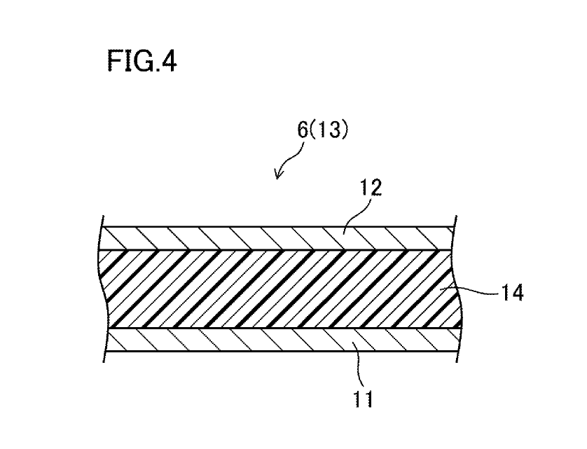

As shown in FIG. 4, the upper 6 (a reinforcement portion 13 which will be described later) includes a first fabric material 11 and a second fabric material 12. The first and second fabric materials 11 and 12 are overlaid each other. Each of the first and second fabric materials 11 and 12 is comprised of a stretchable material. Specifically, examples of suitable materials for the first and second fabric materials 11 and 12 include, but are not limited to, woven fabric, knitted fabric, unwoven fabric, synthetic leather, artificial leather, and natural leather.

In particular, as the first and second fabric materials 11 and 12, a mesh fabric having meshes and produced by warp-knitting (e.g., single-raschel knitting or double-raschel knitting) a polyester yarn or a polyurethane yarn may be suitably used, for example. Alternatively, it is also suitable to form each of the first and second fabric materials 11 and 12 using a tricot fabric of a stretchable polyurethane-containing yarn. Such fabric materials are characterized in that the fabric itself tends to become more flexible as the stretchability of the yarn increases, as the diameter of the yarn decreases or as the stitches become coarser. Moreover, employing a mesh fabric (e.g., a single-raschel or double-raschel knit fabric) as the first and second fabric materials 11 and 12 allows the first and second fabric materials 11 and 12 to have an improved stretchability even if the yarn forming the mesh fabric is poorly stretchable. Note that for the shoe S of this embodiment, the first and second fabric materials 11 and 12 are comprised of the same fabric material, as an example (see FIG. 4).

On the other hand, improvement of the stretchability of the first and second fabric materials 11 and 12 can be achieved not only by means of the characteristics of the materials, but also by forming the first and second fabric materials 11 and 12 to be relatively thin. Alternatively, improvement of the stretchability of the first and second fabric materials 11 and 12 can be achieved also by forming one or more slits (not shown) in each of the first and second fabric materials 11 and 12. Varying a degree of stretch of each of the first and second fabric materials 11 and 12 as appropriate enables adjustment of strain rate dependence of the reinforcement portion 13, which will be described later. Note that in this embodiment, the first and second fabric materials 11 and 12 easily stretch in the foot width direction of the shoe S.

As shown in FIG. 4, the upper 6 includes the reinforcement portion 13 to reinforce the mechanical strength of the first and second fabric materials 11 and 12. In the reinforcement portion 13, a reinforcement member 14 is sandwiched between, and integrated with, the first and second fabric materials 11 and 12.

Specifically, in the reinforcement portion 13, the back surface of the reinforcement member 14 is fusion bonded to the front surface of the first fabric material 11, and the front surface of the reinforcement member 14 is fusion bonded to the back surface of the second fabric material 12. A non-limiting exemplary method for producing the reinforcement portion 13 include: hot pressing the first and second fabric materials 11 and 12 having the reinforcement member 14 sandwiched therebetween from the outer surfaces of the first and second fabric materials 11 and 12; and thereafter, providing a cooling treatment to melt areas, of the first and second fabric materials 11 and 12, which a melted portion of the reinforcement member 14 has permeated. By this production method, the reinforcement member 14 is fusion bonded to each of the first and second fabric materials 11 and 12. In one preferable embodiment, the reinforcement portion 13 has a thickness ranging from 0.2 mm to 2.0 mm.

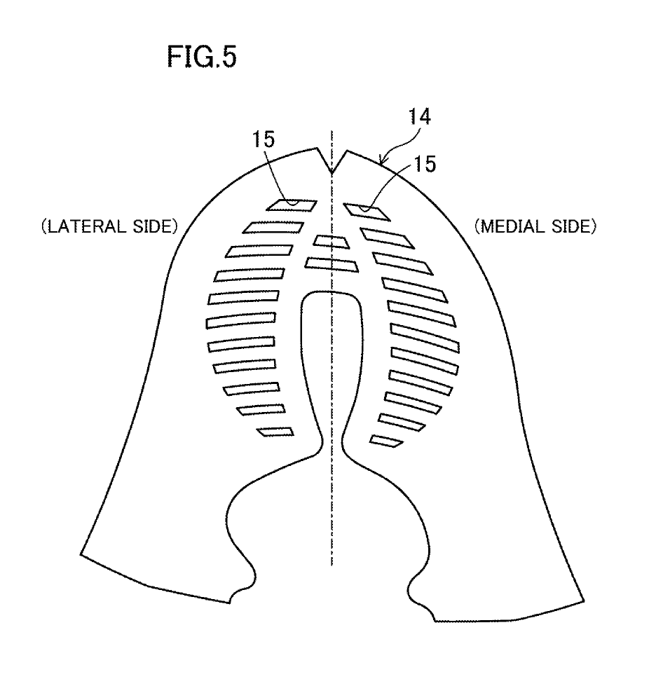

As shown in FIG. 5, the reinforcement member 14 has a sheet shape. Specifically, before being fusion bonded to the first and second fabric materials 11 and 12 and in an expanded state, the reinforcement member 14 has a substantial U-shape in plan view.

Examples of suitable materials for the reinforcement member 14 include thermoplastic elastomers. In view of the fact that the shoes S are mainly used as sport shoes, it is preferable to choose, among the thermoplastic elastomers, one having such physical properties that a value (so-called tanδ) obtained by dividing a loss elastic modulus E″ by a storage elastic modulus E′ exhibits a peak value in a room temperature range. Note that the room temperature range as used herein refers to a temperature range in an atmospheric environment, within which various athletic games are played. Specifically, the room temperature range within which the tanδ reaches the peak value is preferably equal to or higher than 0° C. and lower than 40° C.

It is generally said that a temperature corresponding to the peak value of tanδ is a glass transition point Tg. The glass transition point Tg has been known to influence the temperature dependence and the rate dependence of a resin material. A thermoplastic elastomer, which possesses such physical properties that the tanδ described above exhibits the peak value in the room temperature range, has its glass transition point Tg in the room temperature range, and the thermoplastic elastomer becomes more likely to exhibit the rate dependence as the viscosity (loss elastic modulus E″) increases and/or the elasticity (storage elastic modulus E′) decreases in the room temperature range. That is, employing a thermoplastic elastomer having the physical properties described above as the reinforcement member 14 enables enhancement of the strain rate dependence of the reinforcement portion 13 within the room temperature range in the atmospheric environment. The strain rate dependence will be described later.

Specifically, a thermoplastic elastomer comprised of a composition containing a 4-methyl-1-pentene α-olefin copolymer (manufactured by Mitsui Chemicals, Inc.) is suitably used as a material for the reinforcement member 14. A thermoplastic elastomer containing this composition or any other similar composition can be configured such that the tanδ reaches the peak value in the room temperature range and the hardness of the thermoplastic elastomer has a practical value suitable for the embodiments of the present disclosure, by adjusting the blend amount of an olefin polymer component such as polypropylene (PP) and the blend amount of an olefin rubber component such as ethylene propylene rubber (EPR) and ethylene propylene diene rubber (EPDM).

Other specific examples of the thermoplastic elastomer include olefin-based thermoplastic elastomers, urethane-based thermoplastic elastomers, and styrene-based thermoplastic elastomers. In particular, to reduce the weight of the upper 6, an olefin-based thermoplastic elastomer is more preferable.

As shown in FIG. 1, in this embodiment, the reinforcement portion 13 occupies the entirety of the upper 6. That is, the upper 6 is comprised of the reinforcement portion 13. The lower end of the reinforcement portion 13 is fixed to the periphery of an upper portion of the upper midsole 3, while the upper end of the reinforcement portion 13 is sewn to the periphery of the eyelet trimming part 7 and the periphery of the ankle opening 6a. As a result, as shown in FIGS. 2 and 3, the reinforcement member 14 extends continuously from the upper periphery of the upper midsole 3 to cover a region corresponding to the proximal phalanxes and the metatarsals. Optionally, the reinforcement member 14 extends continuously to reach the eyelet trimming part 7 corresponding to the cuneiform bone, the navicular bone, and the cuboid bone. In other words, the reinforcement portion 13 is configured such that the reinforcement member 14 extends continuously from the upper portion of the midsole 2 to a position corresponding to the foot instep region of the wearer's foot.

As shown in FIGS. 1 to 3 and FIG. 5, the reinforcement member 14 has a plurality of slits 15, 15, . . . arranged at intervals in the longitudinal direction. Each slit 15 has a substantially rectangular shape, and is formed such that its long sides extend in the foot width direction.

Specifically, some of the slits 15, 15, . . . , are arranged in an area which is adjacent to the medial side of the foot and corresponds to a region continuous from the forefoot F to the midfoot M. Likewise, some of the slits 15, 15, . . . , are arranged in an area which is adjacent to the lateral side of the foot and corresponds to a region continuous from the forefoot F to the midfoot M. Arranging the slits 15, 15, . . . in this manner, i.e., in the area adjacent to the medial side and the area adjacent to the lateral side allows the upper 6 (reinforcement portion 13) to have an increased flexibility in the area corresponding to the region which is continuous from the forefoot F to the midfoot M and in which many joints are located, while improving the air permeability of the same area.

The reinforcement portion 13 has such strain rate dependence that with increase in a strain rate in a stretch direction of the first and second fabric materials 11 and 12 that serve as the base material of the upper 6, a tensile load per unit width with respect to a strain amount increases and the reinforcement portion 13 becomes less stretchable. Due to this strain rate dependence, the reinforcement portion 13 has a higher tensile load per unit width with respect to a strain amount and is less stretchable when the strain rate in the stretch direction of the first and second fabric materials 11 and 12 is in a high strain rate region with strain rates above a reference strain rate than when the strain rate is in a low strain rate region with strain rates at or below the reference strain rate. That is, the reinforcement portion 13 is relatively flexible and easy to stretch in the low strain rate region, while it is harder and less stretchable in the high strain rate region than in the low strain rate region.

Here, the “tensile load per unit width” refers to the value of a tensile load (N/mm) applied to a unit width, where a direction intersecting with the stretch direction of the first and second fabric materials 11 and 12 is defined as the width direction of the reinforcement portion 13, and a dimension of the reinforcement portion 13 in the width direction is converted to the unit width of 1 mm. More specifically, it is general to determine the strain rate dependence based on a change in tensile stress with respect to stain amount. However, in this embodiment, in view of the fact that the reinforcement portion 13 is unlikely to have a strictly uniform thickness due to its combined structure including the first and second fabric materials 11, 12 and the reinforcement member 14, the concept of “tensile load per unit width” is employed to determine the strain rate dependence of the reinforcement portion 13, instead of the concept of stress described as a force per unit cross-sectional area (N/mm²).

For the sake of convenience in describing this embodiment, as an example, a strain rate of, for example, 100%/s is defined as the “reference strain rate”, and a strain rate region with strain rates equal to or lower than the reference strain rate (e.g., a strain rate region from 4.2%/s to 100%/s) is defined as the “low strain rate region,” while a strain rate region with strain rates higher than the reference strain rate (e.g., a strain rate region less than or equal to 500%/s and greater than 100%/s) is defined as the “high strain rate region.”

### (Effects of First Embodiment)

In the shoe S, the reinforcement portion 13 of the upper 6 has the strain rate dependence described above. Thanks to this, when a gentle external force is applied to the upper 6 (i.e., when the strain rate is in the low strain rate region), such as when a wearer puts on the shoes S, the upper 6 is relatively flexible and easy to stretch. Consequently, the upper 6 suitably fits with the shape of wearer's foot, and he/she is allowed to smoothly put on the shoes S. On the other hand, when sudden force is applied to the upper 6 (i.e., when the strain rate is in the high strain rate region), such as when the wearer does heavy exercise, the upper 6 is relatively hard and difficult to stretch. As a result, the wearer's foot is covered with, and firmly held by, the upper 6. Thus, the shoes S can have both the fitting properties and the holding properties, and exhibit the fitting or holding properties according to a state of usage.

Further, in the reinforcement portion 13, the reinforcement member 14 is sandwiched between, and integrated with, the first and second fabric materials 11 and 12. That is, the reinforcement member 14 is protected by the first and second fabric materials 11 and 12 and located inside the upper 6. Consequently, the reinforcement member 14 is less likely to be affected by an outside air temperature and a body temperature of the foot. In addition, the risk of being caught on an object when the wearer is playing an athletic game is reduced, for example, thereby substantially preventing the reinforcement member 14 from peeling off the first and second fabric materials 11 and 12. As a result, the reinforcement portion 13 has stable temperature dependence, and damage to the reinforcement portion 13 can be substantially prevented.

Furthermore, the reinforcement portion 13 is configured such that the reinforcement member 14 extends continuously from the upper portion of the midsole 2 to the position corresponding to the foot instep region of the wearer's foot. Therefore, a region, of each foot of the wearer of the shoes S, which is continuous from a lower region close to the planta to the foot instep region is covered with the reinforcement portion 13 in three dimensions. As a result, the above-described effects of the strain rate dependence of the reinforcement portion 13 (i.e., the fitting and holding properties exhibited according to a state of usage) can be provided to the region described above in three dimensions. Moreover, the reinforcement member 14 that extends continuously from the upper portion of the midsole 2 to an area corresponding to the foot instep region results in a decrease in the points described above from which the reinforcement member 14 could peel off, and the risk of damage to the reinforcement portion 13 can be reduced.

As can be seen from the foregoing, according to the first embodiment of the present disclosure, the upper 6 can have both fitting properties and holding properties and exhibit the fitting or holding properties according to a state of usage, and the risk of damage to the reinforcement portion 13 can be reduced, thereby prolonging the life of the shoe S.

In addition, in the reinforcement portion 13, the back surface of the reinforcement member 14 is fusion bonded to the front surface of the first fabric material 11, and the front surface of the reinforcement member 14 is fusion bonded to the back surface of the second fabric material 12. As a result, the reinforcement member 14 is firmly fixed to the first and second fabric materials 11 and 12. This allows the reinforcement member 14 to easily follow the expansion and contraction of the first and second fabric materials 11 and 12, and to be less likely to peel off the first and second fabric materials 11 and 12.

Further, the plurality of slits 15, 15, . . . formed in the reinforcement member 14 contributes to improvement of the flexibility and air permeability of the reinforcement portion 13. It is also possible to adjust the flexural rigidity and the air permeability of the reinforcement portion 13 as appropriate by changing the shape and the number of the slits 15, 15, . . . formed in the reinforcement member 14.

### Second Embodiment

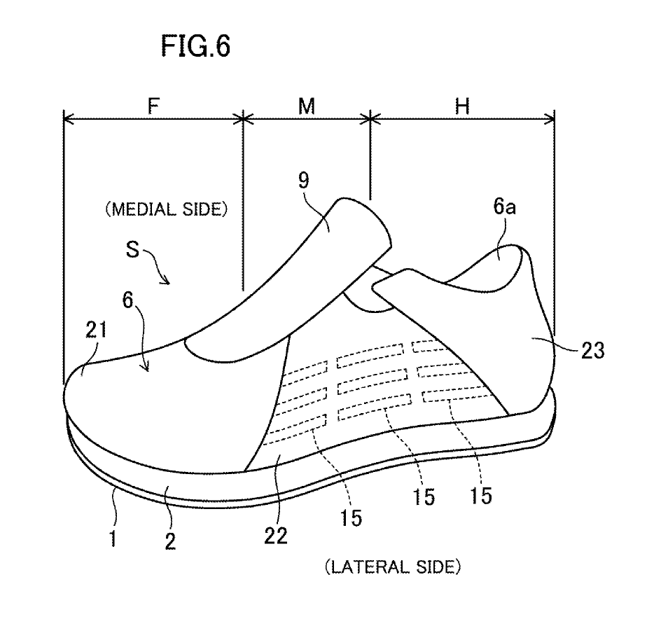

FIG. 6 shows a shoe S according to a second embodiment of the present disclosure. This embodiment differs from the first embodiment described above mainly in the structure of the upper 6. Note that the other components and configuration of the shoe S of this embodiment are the same as or similar to those of the shoe S of the first embodiment described above. Therefore, components that are the same as those shown in FIGS. 1 to 5 are denoted by the corresponding reference characters, and a detailed description thereof is omitted herein.

As shown in FIG. 6, the upper 6 of the shoe S according to this embodiment is comprised of several separate parts respectively corresponding to the forefoot F, the midfoot M, and the hindfoot H of a foot. Specifically, the upper 6 includes an upper's forefoot component 21 arranged to correspond to the forefoot F of the foot and comprised of first and second fabric materials 11 and 12. The upper 6 also includes an upper's hindfoot component 23 arranged to correspond to the hindfoot H of the foot and comprised of the first and second fabric materials 11 and 12. The upper 6 further includes an upper's midfoot component 22 arranged to correspond to the midfoot M of the foot and comprised of a reinforcement portion 13. Note that although FIG. 6 only shows the upper's midfoot component 22 (the reinforcement portion 13) that is arranged at the lateral side, another upper's midfoot component 22 comprised of the reinforcement portion 13 is arranged at the medial side.

The front end of each upper's midfoot component 22 is sewn to the rear end of the upper's forefoot component 21. On the other hand, the rear end of each upper's midfoot component 22 is sewn to the front end of the upper's hindfoot component 23. The top end of each upper's midfoot component 22 is sewn to a corresponding one of the side portions of the tongue 9. That is, the reinforcement member 14 of each upper's midfoot component 22 has its bottom end positioned on the periphery of an upper portion of the upper midsole 3 and the top end positioned on the side portion of the tongue 9 located to correspond to the metatarsals of the foot.

Thus, the shoe S may be configured such that the reinforcement portion 13 forms part of the upper 6, and the top end of the reinforcement member 14 is positioned on the side portion of the tongue 9. In other words, it is suitable to configure the reinforcement portion 13 such that the reinforcement member 14 extends continuously from the upper portion of the midsole 2 to the position corresponding to the foot instep region of the wearer's foot. The shoe S of this embodiment can also obtain similar effects to those of the first embodiment described above.

In this embodiment, slits 15, 15, . . . are arranged at intervals in the longitudinal direction. Each slit 15 has a substantially rectangular shape, and is formed such that its long sides extend in the longitudinal direction. Each slit 15 formed in a front portion of the upper's midfoot component 22 lacks a front portion thereof. Each slit 15 formed in a rear portion of the upper's midfoot component 22 also lacks a rear portion thereof. Thus, each slit 15 is not limited to a shape defining a completely enclosed opening.

### Third Embodiment

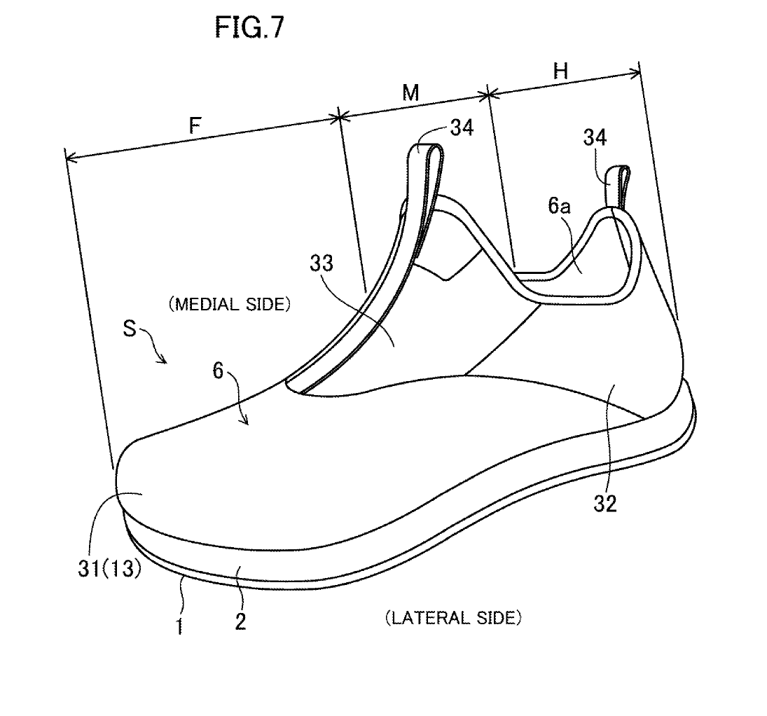

FIG. 7 shows a shoe S according to a third embodiment of the present disclosure. This embodiment differs from the first embodiment described above in the structure of the upper 6; the throat opening 6b and the tongue 9 described in the first embodiment are omitted from this embodiment. Note that the other components and configuration of the shoe S of this embodiment are the same as or similar to those of the shoe S of the first embodiment described above. Therefore, components that are the same as those shown in FIGS. 1 to 5 are denoted by the corresponding reference characters, and a detailed description thereof is omitted herein.

As shown in FIG. 7, the upper 6 of the shoe S according to this embodiment includes front and rear separate parts. Specifically, the upper 6 includes an upper's front component 31 which is arranged to correspond to a region continuous from the forefoot F to a front portion of the hindfoot H of a foot, and which is comprised of a reinforcement portion 13. The upper 6 further includes an upper's rear component 32 which is arranged to correspond to the hindfoot H of the foot, and which is comprised of first and second fabric materials 11 and 12. No slits 15 are formed in the reinforcement portion 13 of this embodiment.

In this embodiment, an upper's top component 33 is provided instead of the tongue 9 described in the first embodiment. The upper's top component 33 is comprised of the first and second fabric materials 11 and 12, and arranged at the position of the tongue 9 of the first embodiment. A tab 34 having a loop-shaped top end is provided to each of the upper's rear and top components 32 and 33.

The bottom end of the upper's front component 31 and that of the upper's rear component 32 are fixed to the periphery of an upper portion of the midsole 2. On the other hand, the rear end of the upper's front component 31 is sewn to the front end of the upper's rear component 32. Further, the top end of the upper's front component 31 is sewn to a front portion of the bottom end of the upper's top component 33, while the top end of the upper's rear component 32 is sewn to a rear portion of the bottom end of the upper's top component 33.

As can be seen, the shoe S may be configured such that the reinforcement portion 13 forms part of the upper 6, and the top end of the reinforcement member 14 is joined to a portion of the upper 6, such as the upper's top component 33. In other words, it is suitable to configure the reinforcement portion 13 such that the reinforcement member 14 extends continuously from the upper portion of the midsole 2 to the position corresponding to the foot instep region of the wearer's foot. The shoe S of this embodiment can also obtain similar effects to those of the first embodiment described above.

In this embodiment, the upper's top component 33 is comprised of the first and second fabric materials 11 and 12. However, this is merely a non-limiting example. That is, the upper's top component 33 may be comprised of the reinforcement portion 13.

### [Other Embodiments]

In the embodiments described above, the same mesh fabric is used as the first and second fabric materials 11 and 12. However, this is merely a non-limiting example. Specifically, the first and second fabric materials 11 and 12 do not have to be made of the same mesh material. They may be formed of different materials such as a mesh fabric and a tricot fabric, and combined with each other.

In the embodiments described above, the reinforcement portion 13 has a thickness ranging from 0.2 mm to 2.0 mm. However, the thickness is not limited to this range. For example, the thickness of the reinforcement portion 13 may be set to be larger than 2.0 mm. As the thickness of the reinforcement portion 13 increases, the stress with respect to the strain amount increases. Changing the thickness of the reinforcement portion 13 as appropriate enables adjustment of the strain rate dependence of the reinforcement portion 13.

In the embodiment described above, the reinforcement member 14 is fusion bonded to the first and second fabric materials 11 and 12 by the hot pressing and cooling treatment. However, this is merely a non-limiting example. For example, the reinforcement member 14 may be injection molded, and then fixed to the first and second fabric materials 11 and 12.

In the reinforcement portion 13 of the embodiments described above, the back surface of the reinforcement member 14 is fusion bonded to the front surface of the first fabric material 11, and the front surface of the reinforcement member 14 is fusion bonded to the back surface of the second fabric material 12. However, this is merely a non-limiting example. For example, the reinforcement member 14 may be integrated with the first and second fabric materials 11 and 12 by adhesion with an adhesive, primer treatment, fixing by sewing, or any other means.

Alternatively, the reinforcement member 14 may be integrated with the first and second fabric materials 11 and 12 by the following method: an extensible thermoplastic film (not shown) (i.e., a hot-melt adhesive) is applied to each of the back surface of the first fabric material 11 and the front surface of the second fabric material 12; and the reinforcement member 14 is bonded to the first and second fabric materials 11 and 12 via the thermoplastic films. This configuration makes it possible to bond the reinforcement member 14 to each of the first and second fabric materials 11 and 12, with the thermoplastic film separating the reinforcement member 14 from each of the first and second fabric materials 11 and 12, while substantially preventing part of the thermoplastic elastomer (the reinforcement member 14) from permeating the first and second fabric materials 11 and 12. Consequently, the first and second fabric materials 11, 12 and the reinforcement member 14 can be firmly bonded to each other, while substantially preventing the upper 6 from decreasing in stretchability.

In the embodiments described above, in the reinforcement portion 13, the reinforcement member 14 and the first and second fabric materials 11 and 12 are integrated with each other. However, this is merely a non-limiting example. Specifically, it is suitable that the reinforcement member 14 is sandwiched between the first and second fabric materials 11 and 12 and integrated with at least one of the first fabric material 11 or the second fabric material 12.

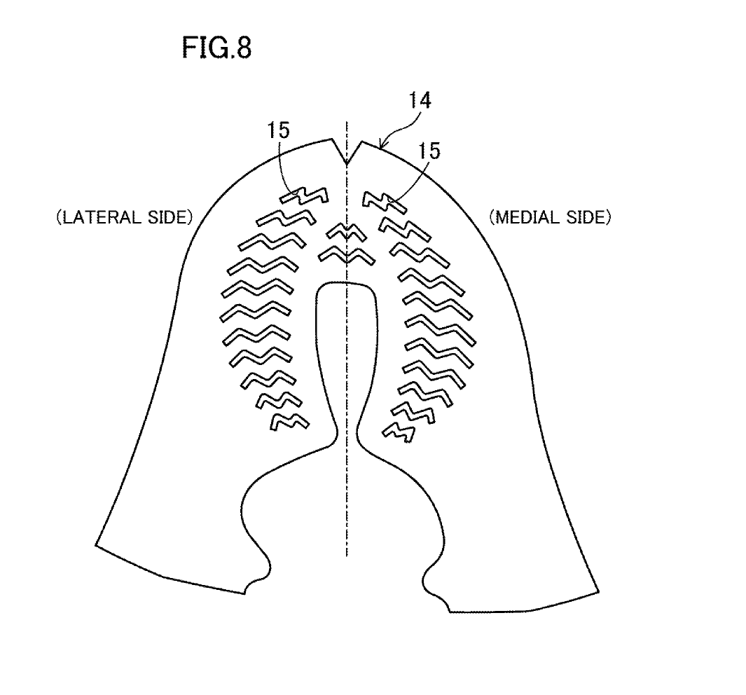

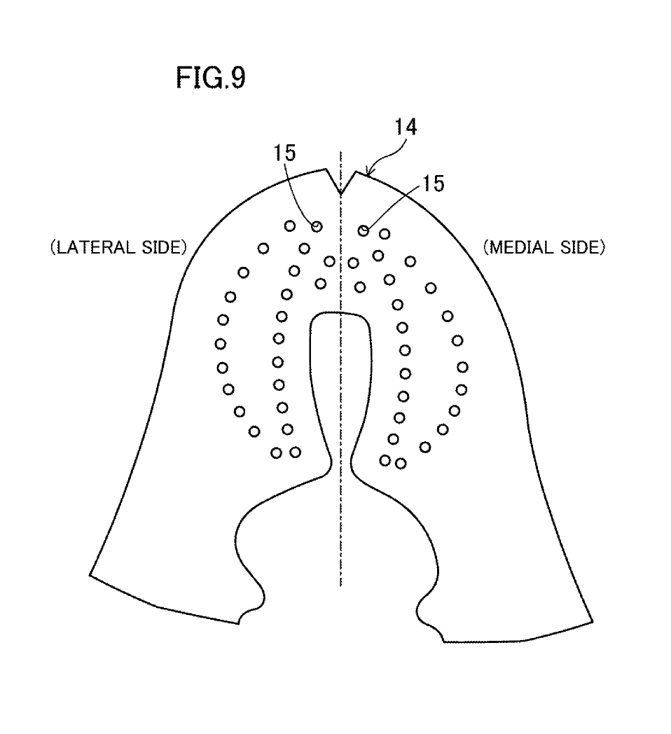

In the first embodiment described above, the reinforcement member 14 with the slits 15, 15, . . . each having a substantially rectangular shape forms part of the reinforcement portion 13. However, this is merely a non-limiting example. For example, FIG. 8 shows a first variation of the reinforcement member 14, in which slits 15, 15, . . . each having a substantially wavy form are formed. Alternatively, a second variation of the reinforcement member 14 shown in FIG. 9 may be adopted, in which holes 15, 15, . . . each having a substantially circular shape are formed. These variations of the reinforcement member 14 may also be adopted to the reinforcement portion 13 of the shoe S of the second embodiment described above.

In the embodiments described above, the slits 15, 15, . . . are formed in the reinforcement member 14. However, this is merely a non-limiting example. Thus, the slits 15, 15, . . . do not have to be formed in the reinforcement member 14.

In the embodiments described above, the upper 6 includes the combination of the first and second fabric materials 11 and 12 in a portion, and the reinforcement member 14 interposed between fabric materials 11 and 12 (i.e., the reinforcement portion 13) in another portion. However, this is merely a non-limiting example. For example, the upper 6 may include, in a portion where the reinforcement member 14 is absent, any one of the first fabric material 11 or the second fabric material 12 as a single layer. Alternatively, the upper 6 may include, in a portion where the reinforcement member 14 is absent, a structure including a material other than the first and second fabric materials 11 and 12.

Note that the present disclosure is not limited to the embodiments described above, and various changes and modifications may be made without departing from the scope of the present disclosure.

### EXAMPLES

### [Dynamic Viscoelasticity Measurement]

First, a dynamic viscoelasticity of each of the following samples of the reinforcement member was measured. Based on the measurement results, the behavior of the loss tangent tanδ described in the first embodiment was observed.

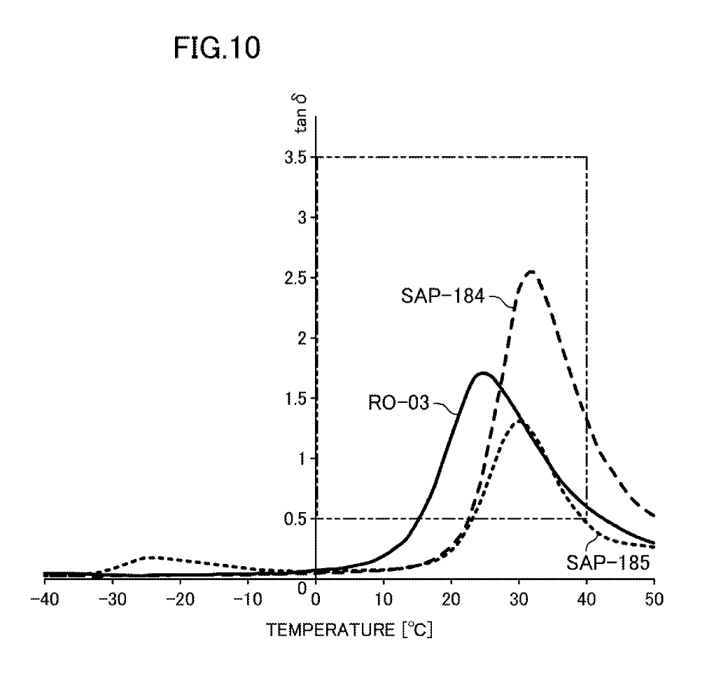

In the measurement, three types of elastomer materials, namely RO-03, SAP-184, and SAP-185, were used as the samples of the reinforcement member described in the above embodiments. These samples each include an olefin-based thermoplastic elastomer as its main ingredient. Note that each of RO-03 and SAP-184 is an elastomer material including a predetermined amount of a composition containing 4-methyl-1 pentene a olefin copolymer (manufactured by Mitsui Chemicals, Inc.) and a predetermined amount of another olefin-based elastomer. SAP-185 is an elastomer material including a predetermined amount of a composition containing 4-methyl-1 pentene a olefin copolymer (manufactured by Mitsui Chemicals, Inc.) and a predetermined amount of a styrene-based elastomer. The equipment, conditions, and the like used in the measurement are shown in Table 1. The results of the measurement are shown in FIG. 10. The measurement was conducted in a tensile vibration mode, and based on combined waves of sine waves at six frequencies, i.e., 1 Hz, 2 Hz, 4 Hz, 8 Hz, 16Hz, 32 Hz, and 64Hz. Among these frequencies, components of which the frequency corresponds to 2 Hz were extracted and are shown. That is, in the measurement, the loss tangent tanδ of the sine wave at 2 Hz was measured based on the combined wave.

TABLE 1

| Type (Product Number) of | Rheogel-E4000 | |
|---|---|---|
| Dynamic Viscoelasticity | (manufactured by UBM Co.) | |
| Measuring Equipment | | |
| Measurement Method | Measurement of Dynamic | |
| | Viscoelasticity Coefficient | |
| | (Combined Wave) | |
| Measurement Mode | Temperature Dependence | |
| Chuck | Tension | |
| Wave Form | Combined Wave N = 6 | |
| Type of Excitation | Stop Excitation | |
| Initial Load | Automatic Static Load | |
| | 200% 25 gram | |
| Width of Samples | 6 | mm |
| Thickness of Samples | 0.5 mm-2 mm | |
| Length of Samples | 20 | mm |
| Start Temperature | −40° | C. |
| Temperature Increment | 2° | C. |
| End Temperature | 50° | C. |
| Rate of Temperature Rise | 2° | C./min |

As shown in FIG. 10, the results of the measurement of the dynamic viscoelasticity of the elastomer material samples have demonstrated that each elastomer material sample has such physical properties that the value of loss tangent tanδ reaches its peak value in the temperature range equal to or higher than 0° C. and lower than 40° C. More specific analysis shows that for Sample RO-03, the tanδ reaches the peak value (i.e., 1.69) at 24° C. For Sample SAP-184, the tanδ reaches the peak value (i.e., 2.55) at 32° C. For Sample SAP-185, the tanδ reaches the peak value (i.e., 1.31) at 30° C. As can be seen, it has been confirmed that the olefin-based thermoplastic elastomers have such physical properties that the value of loss tangent tanδ reaches its peak value in the temperature range at least from 24° C. to 32° C.

The above results show that employing, as the reinforcement member, the elastomer material having such physical properties that the value of loss tangent tanδ reaches its peak value in the temperature range equal to or higher than 0° C. and lower than 40° C. can enhance the strain rate dependence of the reinforcement portion within the room temperature range in atmospheric environment. Further, employing, as the reinforcement member, an olefin-based thermoplastic elastomer having such physical properties that the value of loss tangent tanδ reaches its peak value in the temperature range from 24° C. to 32° C. can further enhance the strain rate dependence of the reinforcement portion within room temperature ranges of common sport facilities. Examples for the strain rate dependence of the reinforcement portion will be described below in the section of Tensile Test.

Meanwhile, elastomer materials having such physical properties that the value of loss tangent tanδ reaches its peak value in the temperature range equal to higher than 0° C. and lower than 40° C. are not limited to the olefin-based thermoplastic elastomers used as the samples for the measurement. For example, urethane-based thermoplastic elastomers, styrene-based thermoplastic elastomers, and the like are presumed to have such physical properties that the value of loss tangent tanδ reaches its peak value in the temperature range equal to higher than 0° C. and lower than 40° C.

### [Tensile Test]

Next, using a predetermined tensile tester, static and dynamic uniaxial tensile tests were carried out on Samples 1 to 29 of the reinforcement portion as indicated below. Based on the obtained results, the behavior of tensile load per unit width with respect to a strain rate (strain rate dependence) of each sample was observed. The tensile tests were carried out in a test room in which the temperature and humidity were set to 23° C. and 50%, respectively.

Here, in these tensile tests, the “tensile load per unit width” refers to a tensile load value (N/mm) applied to a unit width, where a direction intersecting with the stretch direction of the fabrics described later (corresponding to the first and second fabric materials) is defined as the width direction and a dimension of each sample in the width direction is converted to the unit width of 1 mm.

For these tensile tests, “ElectroPlus E 3000 electric tester”, a tensile tester manufactured by Instron Japan Co., Ltd. was mainly used. As the main points of the specifications of this tensile tester, the dynamic load capacity is ±3000 N and the stroke is 60 mm. The tensile tester is capable of performing static and dynamic tensile tests on various materials and the like within the operation temperature range from 10° C. to 30° C. For some of the fabric materials (specifically, ST2 and ST3 which will be described later), “3365-Type Electromechanical Universal Material Tester,” a tensile tester manufactured by Instron Japan Co., Ltd. was used, instead of the ElectroPlus E 3000 electric tester, at low strain rates of 4%/s and 42%/s. The load cell of this tensile tester has a dynamic load capacity of ±1000 N. The tensile tester is capable of performing static and dynamic tensile tests on various materials and the like within the operation temperature range from 10° C. to 38° C.

As the first and second fabric materials forming the reinforcement portion, fabric materials ST1, ST2, and ST3 each produced by warp-knitting (tricot knitting) a polyurethane-containing yarn, a mesh fabric material MD produced by warp-knitting (double-raschel knitting) a polyester yarn, and a mesh fabric material HD produced by warp-knitting (single-raschel knitting) a polyester yarn were used. Each fabric material was configured to stretch in the longitudinal direction of the corresponding sample. The fabric materials were different from each other in degree of stretch, depending on their specifications (the material(s) constituting the yarn, the yarn diameter, the coarseness of the stitches, the thickness of the fabric material itself, etc.). In this example, the fabric materials ST1, ST2, ST3, MD, and HD were designed so as to be less stretchable (harder) in this order.

As the reinforcement member, three types of elastomer materials, namely RO-03, SAP-184, and SAP-185, were used. These elastomer materials each contain an olefin-based thermoplastic elastomer as its main ingredient. Sheets of the elastomer material RO-03 each having a thickness of 0.2 mm, 0.5 mm, 1.0 mm, or 2.0 mm were prepared and used. For each of the elastomer materials SAP-184 and SAP-185, sheets having a thickness of 0.4 mm, 0.8 mm, or 2.0 mm were prepared and used.

The fabric materials and the elastomer materials were appropriately combined with each other to produce the Samples 1 to 29 of the reinforcement portion (see Tables 2 to 7 for combinations of the fabric materials and the elastomer materials).

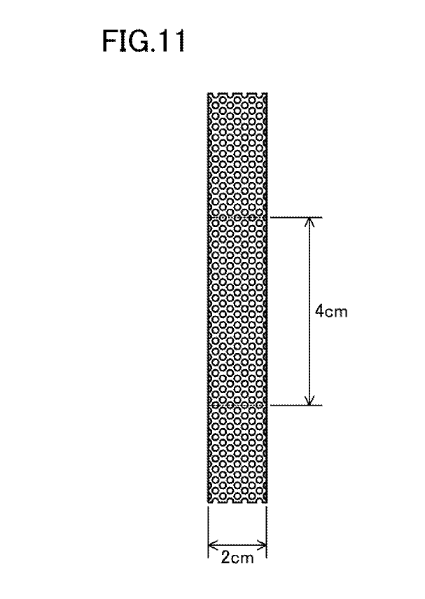

The samples were produced in the following manner. Two pieces of the same fabric material having one elastomer material sandwiched therebetween were hot pressed from outer surfaces of the two pieces using a hot press machine; and thereafter, a cooling treatment was provided to melt areas, of the pieces of the fabric material, which a melted portion of the elastomer material permeated. In this manner, each elastomer material was fusion bonded to the associated fabric material. As shown in FIG. 11, each sample was prepared so as to have, at a portion set on the tensile tester described above (the portion defined by the dotted lines in FIG. 11), a length dimension of 4 cm in the stretch direction of the associated fabric material, and a dimension of 2 cm in the width direction. The length dimension (4 cm) corresponds to the distance (the initial value) between the specimen clips of each tensile tester.

Each of the samples was subjected to uniaxial tensile tests at four different strain rates (i.e., 4.2%/s, 42%/s, 100%/s, and 500%/s) using the tensile tester described above at an atmospheric temperature set to be within the room temperature range. Based on the results of the tests (i.e., the relationship between a strain and a tensile load per unit width), the presence and absence of strain rate dependence and a suitable range of tensile load P per unit width (N/mm) with respect to a strain amount were studied. Tables 2 to 4 below show values of tensile load P per unit width (N/mm) of Samples 1 to 29 at a respective strain rates when the strain amount was 1%.

TABLE 2

| [Type of elastomer | | | | | | |
|---|---|---|---|---|---|---|
| material] RO-03 | | | | | | |
| <Strain amount of 1%> | | | Strain rate (%/s) | | | |
| | | Type of | 4.2%/s | 42%/s | 100%/s | 500%/s |
| Sample | Thickness | fabric | P | P | P | P |
| No. | t (mm) | material | (N/mm) | (N/mm) | (N/mm) | (N/mm) |
| 1 | t = 0.2 | ST1 | 0.11 | — | — | 2.20 |
| 2 | | MD | 0.23 | — | — | 1.57 |
| 3 | | HD | 0.38 | — | — | 1.99 |
| 4 | t = 0.5 | ST2 | 0.28 | 0.23 | 1.23 | 0.84 |
| 5 | | ST3 | 0.18 | 0.20 | 0.62 | 1.38 |
| 6 | t = 0.1 | ST1 | 0.19 | 0.44 | 0.70 | 1.59 |
| 7 | | MD | 1.05 | 1.52 | 1.77 | 3.10 |
| 8 | | HD | 2.22 | 3.47 | 4.34 | 5.90 |
| 9 | t = 2.0 | ST1 | 0.25 | — | — | 2.02 |
| 10 | | MD | 0.78 | — | — | 3.90 |
| 11 | | HD | 1.98 | — | — | 5.69 |

TABLE 3

| [Type of elastomer | | | | | | |
|---|---|---|---|---|---|---|
| material] SAP-184 | | | | | | |
| <Strain amount of 1%> | | | Strain rate (%/s) | | | |
| | | Type of | 4.2%/s | 42%/s | 100%/s | 500%/s |
| Sample | Thickness | fabric | P | P | P | P |
| No. | t (mm) | material | (N/mm) | (N/mm) | (N/mm) | (N/mm) |
| 12 | t = 0.4 | ST1 | 0.15 | — | — | 1.15 |
| 13 | | ST2 | 0.39 | 0.20 | 0.76 | 1.64 |
| 14 | | ST3 | 0.55 | 0.25 | 1.25 | 2.26 |
| 15 | | MD | 0.41 | — | — | 1.91 |
| 16 | | HD | 1.48 | — | — | 3.17 |
| 17 | t = 0.8 | ST1 | 0.47 | 1.07 | 1.39 | 2.42 |
| 18 | t = 2.0 | ST1 | 0.73 | — | — | 4.37 |
| 19 | | MD | 1.44 | — | — | 4.86 |
| 20 | | HD | 1.95 | — | — | 7.11 |

TABLE 4

| [Type of elastomer | | | | | | |
|---|---|---|---|---|---|---|
| material] SAP-185 | | | | | | |
| <Strain amount of 1%> | | | Strain rate (%/s) | | | |
| | | Type of | 4.2%/s | 42%/s | 100%/s | 500%/s |
| Sample | Thickness | fabric | P | P | P | P |
| No. | t (mm) | material | (N/mm) | (N/mm) | (N/mm) | (N/mm) |
| 21 | t = 0.4 | ST1 | 0.22 | — | — | 1.25 |
| 22 | | ST2 | 0.57 | 0.19 | 1.02 | 1.41 |
| 23 | | ST3 | 0.52 | 0.24 | 1.01 | 1.31 |
| 24 | | MD | 1.32 | — | — | 2.85 |
| 25 | | HD | 2.07 | — | — | 3.87 |
| 26 | t = 0.8 | ST1 | 0.53 | 0.72 | 1.37 | 2.03 |
| 27 | t = 2.0 | ST1 | 0.86 | — | — | 3.47 |
| 28 | | MD | 1.82 | — | — | 3.97 |
| 29 | | HD | 3.86 | — | — | 5.04 |

Likewise, Tables 5 to 7 show values of tensile load P per unit width (N/mm) of

Samples 1 to 29 at respective strain rates when the strain amount was 5%.

TABLE 5

| [Type of elastomer | | | | | | |
|---|---|---|---|---|---|---|
| material] RO-03 | | | | | | |
| <Strain amount of 5%> | | | Strain rate (%/s) | | | |
| | | Type of | 4.2%/s | 42%/s | 100%/s | 500%/s |
| Sample | Thickness | fabric | P | P | P | P |
| No. | t (mm) | material | (N/mm) | (N/mm) | (N/mm) | (N/mm) |
| 1 | t = 0.2 | ST1 | 0.16 | — | — | 4.60 |
| 2 | | MD | 0.74 | — | — | 3.34 |
| 3 | | HD | 2.59 | — | — | 6.22 |
| 4 | t = 0.5 | ST2 | 0.69 | 1.68 | 2.36 | 1.16 |
| 5 | | ST3 | 0.36 | 1.20 | 0.99 | 3.29 |
| 6 | t = 0.1 | ST1 | 0.37 | 0.95 | 1.72 | 3.91 |
| 7 | | MD | 3.38 | 4.55 | 4.80 | 8.14 |
| 8 | | HD | 7.70 | 10.69 | 12.25 | 15.40 |
| 9 | t = 2.0 | ST1 | 0.54 | — | — | 5.50 |
| 10 | | MD | 2.84 | — | — | 10.79 |
| 11 | | HD | 6.50 | — | — | 14.92 |

TABLE 6

| [Type of elastomer | | | | | | |
|---|---|---|---|---|---|---|
| material] SAP-184 | | | | | | |
| <Strain amount of 5%> | | | Strain rate (%/s) | | | |
| | | Type of | 4.2%/s | 42%/s | 100%/s | 500%/s |
| Sample | Thickness | fabric | P | P | P | P |
| No. | t (mm) | material | (N/mm) | (N/mm) | (N/mm) | (N/mm) |
| 12 | t = 0.4 | ST1 | 0.28 | — | — | 2.47 |
| 13 | | ST2 | 0.73 | 1.50 | 1.86 | 3.27 |
| 14 | | ST3 | 0.87 | 2.14 | 2.25 | 4.47 |
| 15 | | MD | 1.50 | — | — | 4.87 |
| 16 | | HD | 4.68 | — | — | 8.76 |
| 17 | t = 0.8 | ST1 | 0.71 | 2.05 | 2.75 | 5.19 |
| 18 | t = 2.0 | ST1 | 1.13 | — | — | 10.46 |
| 19 | | MD | 3.20 | — | — | 13.13 |
| 20 | | HD | 5.58 | — | — | 18.80 |

TABLE 7

| [Type of elastomer | | | | | | |
|---|---|---|---|---|---|---|
| material] SAP-185 | | | | | | |
| <Strain amount of 5%> | | | Strain rate (%/s) | | | |
| | | Type of | 4.2%/s | 42%/s | 100%/s | 500%/s |
| Sample | Thickness | fabric | P | P | P | P |
| No. | t (mm) | material | (N/mm) | (N/mm) | (N/mm) | (N/mm) |
| 21 | t = 0.4 | ST1 | 0.56 | — | — | 2.38 |
| 22 | | ST2 | 1.35 | 1.94 | 2.40 | 3.25 |
| 23 | | ST3 | 0.86 | 2.24 | 1.88 | 3.22 |
| 24 | | MD | 4.12 | — | — | 7.67 |
| 25 | | HD | 5.76 | — | — | 10.29 |
| 26 | t = 0.8 | ST1 | 1.05 | 2.13 | 3.11 | 4.71 |
| 27 | t = 2.0 | ST1 | 1.73 | — | — | 9.05 |
| 28 | | MD | 4.57 | — | — | 11.71 |
| 29 | | HD | 9.29 | — | — | 14.91 |

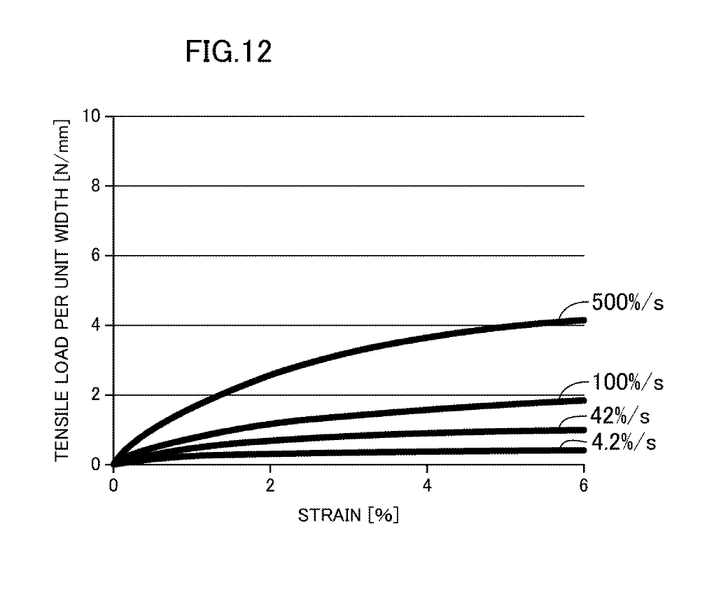

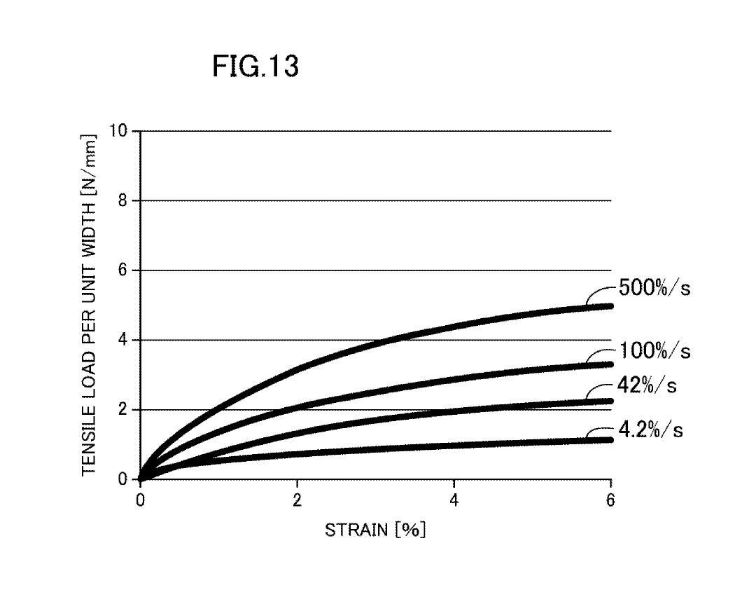

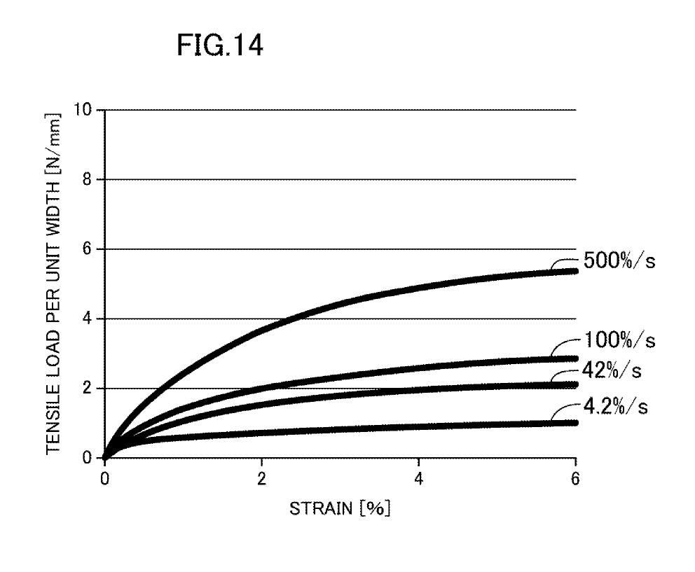

FIGS. 12 to 14 and the results shown in Tables 2 to 7 show that Samples 1 to 29 have such characteristics that they are flexible and easy to stretch in the low strain rate region, while they are harder and less stretchable in the high strain rate region than in the low strain rate region.

Specifically, Tables 2 to 4 show that the tensile load P per unit width (N/mm) with respect to a strain amount of 1% is within the range of 0.11≤P≤4.34 in the low strain rate region, whereas the tensile load P is within the range of 0.84≤P≤7.11 in the high strain rate region. Tables 5 to 7 show that the tensile load P per unit width (N/mm) with respect to a strain amount of 5% is within the range of 0.16≤P≤12.25 in the low strain rate region, whereas the tensile load P is within the range of 1.16≤P≤18.80 in the high strain rate region.

As a result of further consideration, it has been found that at a strain amount of 1%, the upper limit value (7.11 N/mm) of the tensile load per unit width in the high strain rate region is about 1.6 times as large as the upper limit value (4.34 N/mm) of the tensile load per unit width within the low strain rate region. Further, it has been found that at a strain amount of 5% (corresponding to an average strain amount generated when an external force is applied to the upper of the known sport shoes), the upper limit value (18.80 N/mm) of the tensile load per unit width in the high strain rate region is about 1.5 times as large as the upper limit value (12.25 N/mm) of the tensile load per unit width in the low strain rate region. Based on these results, use of the samples of the reinforcement portion as the uppers of sport shoes makes it possible to further reliably obtain the effects described in the embodiments: the sport shoes have both the fitting property and the holding property, and exhibit the fitting or holding properties according to a state of use.

As described above, it has been concluded that the reinforcement portion of the shoe S of the present disclosure has such strain rate dependence that a tensile load per unit width with respect to a strain amount is higher and the reinforcement portion is less stretchable when a strain rate of the reinforcement portion in the stretch direction of the first and second fabric materials is in the high strain rate region with strain rates above the reference strain rate than when the strain rate of the reinforcement portion is in the low strain rate region with strain rates at or below the reference strain rate.

The present disclosure is industrially applicable, for example, as sport shoes for running and other various athletic games.

What is claimed is:

1. A sport shoe comprising:
a sole configured to support a plantar surface of a foot of a wearer; and
an upper coupled to an upper portion of the sole and configured to cover the wearer's foot, wherein
the upper includes
a first fabric material and a second fabric material which are stretchable and overlaid each other, and
a reinforcement portion which has such strain rate dependence that in a room temperature range, as a strain rate in a stretch direction of the first and second fabric materials increases, a tensile load per unit width with respect to a strain amount increases and the reinforcement portion becomes less stretchable, and
in the reinforcement portion,
a reinforcement member made of a thermoplastic elastomer is sandwiched between the first and second fabric materials and integrated with at least one of the first or second fabric materials, and
the reinforcement member extends continuously from the upper portion of the sole to a position corresponding to a foot instep region of the wearer's foot.

2. The sport shoe of claim 1, wherein
in the reinforcement portion, a back surface of the reinforcement member is fusion bonded to a front surface of the first fabric material, and a front surface of the reinforcement member is fusion bonded to a back surface of the second fabric material.

3. The sport shoe of claim 1, wherein
the reinforcement member has a plurality of slits or holes formed in the reinforcement member.

4. The sport shoe of claim 1, wherein
a measurement of a sample of the reinforcement member performed using dynamic viscoelasticity measuring equipment shows that the reinforcement member has such physical properties that a value of loss tangent tanδ reaches a peak value in the room temperature range equal to higher than 0° C. and lower than 40° C.,
where the measurement is performed under conditions that a rate of temperature rise is set to be 2° C./min, the temperature rise is started from −40° C., a temperature increment is set to be 2° C., and the temperature rise is ended at 50° C.

5. The sport shoe of claim 4, wherein
the reinforcement member is made of an olefin-based thermoplastic elastomer, and a measurement of a sample of the reinforcement member performed using the dynamic viscoelasticity measuring equipment shows that the reinforcement member has such physical properties that the value of loss tangent tanδ reaches a peak value in the temperature range from 24° C. to 32° C.,
where the measurement is performed under conditions that a rate of temperature rise is set to be 2° C./min, the temperature rise is started from −40° C., a temperature increment is set to be 2° C., and the temperature rise is ended at 50° C.

6. The sport shoe of claim 4, wherein
a direction intersecting with the stretch direction of the first and second fabric materials is defined as a width direction,
for the reinforcement portion, a strain rate of 100%/s in the stretch direction of the first and second fabric materials is defined as a reference strain rate,
a strain rate region with strain rates higher than the reference strain rate is defined as a high strain rate region,
a strain rate region with strain rates equal to or lower than the reference strain rate is defined as a low strain rate region, and
in a tensile test conducted on a sample of the reinforcement portion under conditions that ambient temperature of a tensile tester is within the room temperature region, the reinforcement portion exhibits such strain rate dependence that the tensile load per unit width with respect to the strain amount is higher and the reinforcement portion is less stretchable when the strain rate of the reinforcement portion is in the high strain rate region than when the strain rate of the reinforcement portion is in the low strain rate region.

7. The sport shoe of claim 6, wherein
a relationship between the strain and the tensile load per unit width determined by the tensile test is that the tensile load P per unit width (N/mm) with respect to a strain amount of 1% is within the range of 0.11≤P≤4.34 in the low strain rate region, whereas the tensile load P is within the range of 0.84≤P≤7.11 in the high strain rate region.

8. The sport shoe of claim 6, wherein
a relationship between the strain and the tensile load per unit width determined by the tensile test is that the tensile load P per unit width (N/mm) with respect to a strain amount of 5% is within the range of 0.16≤P≤12.25 in the low strain rate region, whereas the tensile load P is within the range of 1.16≤P≤18.80 in the high strain rate region.
